(19) United States
(12) Patent Application Publication
(10) Pub. No.: US 2020/0053995 A1
(43) Pub. Date: Feb. 20, 2020

(54) ATTACHMENT KITS FOR FISH-LANDING NETS AND ASSOCIATED SYSTEMS AND METHODS

(71) Applicant: James Andrews, Montesano, WA (US)

(72) Inventor: James Andrews, Montesano, WA (US)

(21) Appl. No.: 16/540,310

(22) Filed: Aug. 14, 2019

Related U.S. Application Data
(60) Provisional application No. 62/718,819, filed on Aug. 14, 2018.

(51) Int. Cl. A01K 77/00

(52) U.S. Cl. CPC A01K 77/00

(57) ABSTRACT

An attachment kit configured to attach to a landing net, the attachment kit including an arm bed including: a receptacle having a concave surface for contacting a user's forearm or elbow, and a bed attachment portion operably connected to the receptacle, the bed attachment portion configured to contact a pole portion of the landing net for affixing the arm bed to the pole portion.

### CROSS-REFERENCE TO RELATED APPLICATIONS

This application claims the benefit of U.S. Provisional Patent Application Ser. No. 62/718,819, filed Aug. 14, 2018, which is incorporated by reference herein in its entirety.

### TECHNICAL FIELD

The present technology is directed generally to attachment kits for fish-landing nets, and associated systems and methods.

### BACKGROUND

Fishermen often use fish-landing nets (e.g., landing nets, hand nets, scoop nets, dip nets, etc.) to secure/capture fish. The landing nets can include handheld nets that are used to lift caught fish (e.g., a fish that is hooked on a fishing line) out of the water, such as in angling/fly fishing. The landing nets can include a handle/pole portion connected to a hoop portion that anchors a net portion. A user (e.g., an angler or a fisherman) can hold the handle portion (e.g., at or near a proximal end thereof). The hoop portion and the net portion can be attached to a distal end of the handle portion.

The handle/pole portion can vary in length for different landing nets. Some landing nets can include the handle/pole portion with a length up to four or five feet or more. The landing nets with a relatively long handle/pole portion can be useful in landing a fish while fishing from a boat, and the landing nets with a shorter handle portion can be useful in landing a fish while fishing from shore or in water.

While the landing nets with a longer handle/pole are useful when a person can use both hands to manipulate the net, the additional length can decrease usability when the user manipulates the net with only one hand. For example, a guide or an assistant can use both hands to manipulate the landing net in helping an angler land the fish. However, if the angler is manipulating the landing net, the angler is required to hold the fishing pole in one hand and manipulate the landing net with the other hand. With one hand, the angler has reduced leverage (i.e., in comparison to two-handed use resulting from the lack of a separate fulcrum away from the angler's hand) when manipulating the landing net. Further, with the angler's hand acting as a fulcrum, the angler is required to exert an increasing amount of force to counter the same weight or force on the net portion as the net portion gets further away from the angler. For example, as the pole gets longer, an angler manipulating the landing net would experience an increasing amount of difficulty in dealing with the water flow/current, resistance from the water, the size/weight of the fish, movement of the fish, etc.

### BRIEF DESCRIPTION OF THE DRAWINGS

FIG. 1 is an isometric view of a fish-landing net attachment kit configured in accordance with some embodiments of the present technology.

FIG. 2A is a side view along a direction 2A of FIG. 1 of a fish-landing net attachment kit including a spring-based lock in an engaged position in accordance with some embodiments of the present technology.

FIG. 2B is a side view along the direction A of FIG. 1 of the fish-landing net attachment kit including the spring-based lock in a disengaged position in accordance with some embodiments of the present technology.

FIG. 3A is a side view along the direction A of FIG. 1 of a fish-landing net attachment kit including a clamp-based lock in an engaged position in accordance with some embodiments of the present technology.

FIG. 3B is a side view along the direction A of FIG. 1 of the fish-landing net attachment kit including the clamp-based lock in a disengaged position in accordance with some embodiments of the present technology.

### DETAILED DESCRIPTION

### 1.0 Overview

The present technology is generally directed to attachment kits for providing enhanced one-handed control of fish landing nets. In particular embodiments, an attachment kit can include an arm/elbow portion and/or a handle portion. The arm/elbow portion can be configured to attach to a proximate portion (e.g., closer to the user/angler) of a pole portion of a fish landing net. The arm/elbow portion can include a pad and/or a receptor configured/shaped to contact the user's elbow or forearm. The handle portion can be configured to attach to a distal portion (e.g., closer to a net portion of the landing net and away from the user/angler). The handle portion can include a protrusion extending away from the net pole and is configured/shaped to be grasped by the user's hand.

The arm/elbow portion and the handle portion can each include an attachment mechanism configured to affix the corresponding structure to the pole of the landing net. In particular embodiments, the attachment mechanism can include hand-operated clamp configured to affix or decouple the structure to/from the pole according to forces/controls from the user's hand.

Embodiments of the attachment kit provide the angler with increased control over the landing net. When attached to a conventional landing net, the attachment kit can allow the angler to use his/her forearm or elbow as a fulcrum while using one hand to manipulate/move the fishing net. As such, the angler can use the landing net with increased stability via the attachment kit.

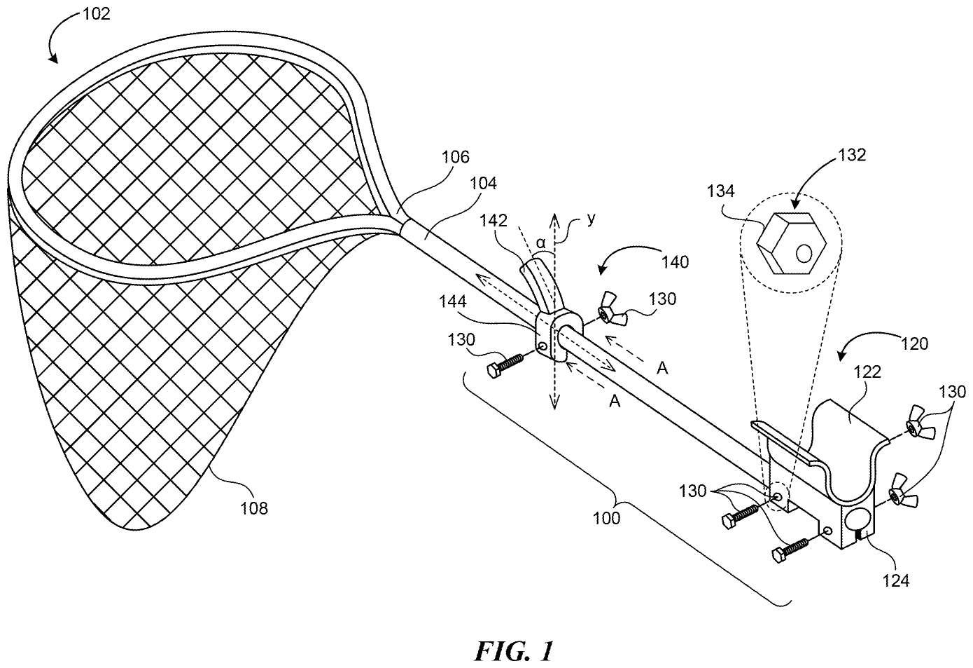

Specific details of representative embodiments of the present technology are described below with reference to selected configurations to provide a thorough understanding of these embodiments, with the understanding that the technology may be practiced in the context of other embodiments. Several details describing structures or processes that are well-known and often associated with fish landing nets, but that may unnecessarily obscure some of the significant aspects of the present disclosure, are not set forth in the following description for purposes of clarity. Moreover, although the following disclosure sets forth some embodiments of different aspects of the technology, some other embodiments of the technology can have configurations and/or components that differ from those described in this section. As such, the technology may have other arrangements or configurations with additional elements and/or without several of the elements described below with reference to FIG. 1. It will be understood that aspects of the technology described in the context of a particular system or subsystem may be combined with other technology aspects described in the context of other subsystems, in any of a variety of suitable manners.

### 2.0 Overall Attachment System

FIG. 1 is an isometric view of a fish-landing net attachment kit (attachment kit) 100 configured in accordance with some embodiments of the present technology. The attachment kit 100 includes a set of fixtures/structures configured to be attached to a fish landing net (landing net) 102 for providing a user (e.g., an angler; not shown) with increased leverage when manipulating/moving the landing net 102.

The landing net 102, according to a conventional design, can include a pole 104 with an open structure (hoop) 106 attached to a first end of the pole 104. The landing net 102 can include a net 108 attached to the hoop 106. In manipulating/using/moving the traditional landing net 102, the user can grab and move the pole 104 to position the hoop 106 in the water and near a target (e.g., a fish) and then scoop the target into the net 108.

The attachment kit 100 can be configured to attach to the pole 104 away from the hoop 106/net 108. The attachment kit 100 can include a first portion (elbow/forearm bed) 120. The first portion 120 can be configured to receive the user's forearm and/or elbow. For example, the first portion 120 can include a receptacle 122 having a concave surface shaped/configured to receive the user's forearm and/or elbow.

The first portion 120 can further include a first attachment portion 124 integral with or attached to the receptacle 122. In some embodiments, the first attachment/body portion 124 can be configured to engage/contact the pole 104. For example, the first attachment portion 124 can have a receptacle (e.g., a hole or a cylindrical void) having a shape, such as a depression or a curved surface having a diameter matching (or approximately matching) that of the pole 104, and configured to contact (e.g., wrap around or surround) a section/location of the pole 104.

The attachment kit 100 can include a second portion (e.g., a hand controller) 140 configured to attach to the pole 104 between the first portion 120 and the hoop 106, and further configured to provide a handle that the user grips. For example, the second portion 140 can include a handle 142 that protrudes away from the pole 104. The handle 142 can have a shape suitable for gripping, e.g., a generally cylindrical/columnar shape, a curved surface (e.g., configured to contact/engage the user's palm), one or more grooves/concave surfaces (e.g., configured to contact/engage the user's fingers), etc., such that the user can grasp the handle 142.

In some embodiments, the handle 142 can protrude toward the hoop 106 and away from an axis (represented as ‘y’ in FIG. 1) that is perpendicular to the pole 104. For example, the protrusion direction of the handle 142 can be tilted 10°-40° away from the perpendicular axis. In some embodiments, the handle 142 can be configured to provide a pistol grip for the user. In some embodiments, the handle 142 can be manufactured using rubberized material.

The second portion 140 can further include a second attachment/body portion 144 integral with or attached to the handle 142. In some embodiments, the second attachment portion 144 can be configured to engage/contact the pole 104. The second attachment portion 144 can be shaped/configured similarly to the first attachment portion 124. For example, the second attachment portion 144 can have a receptacle (e.g., a hole or a cylindrical void) having a shape, such as a depression or a curved surface having a diameter matching or approximately matching that of the pole 104, and configured to contact (e.g., wrap around or surround) a section/location of the pole 104 between the first portion 120 and the hoop 106.

In some embodiments, the first portion 120 and the second portion 140 can be attached together or integrally connected to each other, apart from the pole 104. In some embodiments, the first portion 120 and the second portion 140 can be separate. The first portion 120 and the second portion 140 can each include a fastening mechanism 130 configured to affix the first portion 120 and the second portion 140 to the pole 104. For example, the fastening mechanism 130 can affix the corresponding structure by causing the first attachment portion 124 and/or the second attachment portion 144 to compress against the pole 104.

In some embodiments, the fastening mechanism 130 can be designed for the user to affix or disengage the structure with the user's hand(s), thereby allowing the user to adjust a position (e.g., a location and/or an orientation) of the first portion 120 and/or the second portion 140 without using any tools. For example, the fastening mechanism 130 can include one or more bolts (e.g., counter sunk bolts) with shaped bolt heads and one or more corresponding counter-sink receptacles (e.g., bolt nuts or other structures including a threaded receptacle portion). The counter-sink receptacles can be attached to or integral with handle structures sized/shaped (e.g., wing nuts or bars with bolt hoes) to contact the user's hand and provide sufficient torque to compress and affix the first attachment portion 124 and/or the second attachment portion 144 against the pole 104. The attachment portions 124/144 can include depressions 132 (e.g., receptacles for receiving bolt heads) having perimeter shapes 134 matching the shape of the bolt heads. Accordingly, when the bolts are inserted into the depressions 132, the bolt heads can contact at least portions of sidewalls of the depressions 132 to prevent them from rotating when the user tightens the counter-sink receptacles. Also, the fastening mechanism 130 can include a spring-based lock (e.g., a compression spring or wrap spring) operably coupled to a button or a lever configured to tighten or loosen the spring relative to the pole 104. Also, the fastening mechanism 130 can include a toggle/latch clamp-based design for compressing the attachment portions 124/144 against the pole 104.

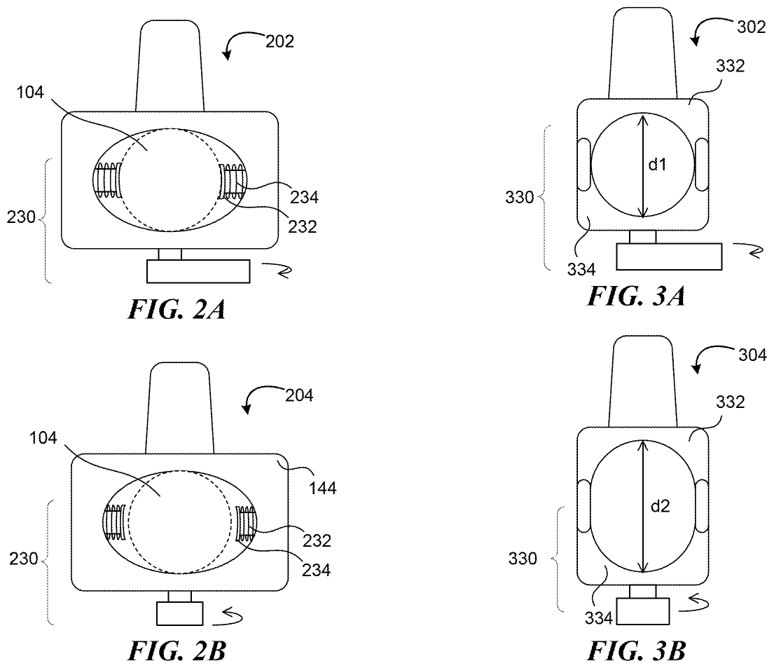

FIG. 2A and FIG. 2B are side views along a direction A of FIG. 1 of the attachment kit 100 including a spring-based lock 230, in accordance with representative embodiments of the present technology. FIG. 2A illustrates the spring-based lock 230 in an engaged position 202. The spring-based lock 230 can include an engagement controller (e.g., a lever or a button) configured to retract or release a compressing member 232. The compressing member 232 can be connected to the attachment portions 122/142 (FIG. 1) and extend toward the pole 104. The compressing member 232 can be operably coupled to (e.g., concentrically positioned and contacting) a spring 234 that is connected to the attachment portions 122/142. The springs 234 can be extend the compressing member 232 to contact the pole 104. In other words, the spring 234 and the compressing member 232 can be biased against the pole 104 to exert a force on the pole 104. Accordingly, when the engagement controller releases the compressing member 232 for the engaged position 202, the springs 234 can compress the compressing member 232 against the pole 104, thereby affixing the attachment portions 122/142 to the pole 104.

FIG. 2B illustrates the spring-based lock 230 in a disengaged position 204. In the disengaged position 204, the compressing member 232 can be retracted via the engagement controller. Accordingly, the compressing member 232 can disengage the pole 104 and remove the corresponding compressing force, allowing the attachment portions 122/142 to be moved or repositioned relative to the pole 104

FIG. 3A and FIG. 3B are side views along the direction A of FIG. 1 of the attachment kit 100 including a clamp-based lock 330, in accordance with representative embodiments of the present technology. FIG. 3A illustrates the clamp-based lock 330 in an engaged position 302. The clamp-based lock 330 can include an engagement controller (e.g., a lever or a button) configured to control relative locations of contacting portions 332 and 334. In some embodiments, the clamp-based lock 330 can include a bar clamp or a hinged clamp that reduces an opening size (e.g., an inner space or inner shape/circumference d1) between the contacting portions 332 and 334. For example, the distance d1 can effectively match a diameter of the pole 104 (FIG. 1). Accordingly, the inner surfaces of the attachment portions 122/142 (FIG. 1) can contact and compress against the pole 104, thereby affixing the attachment portions 122/142 relative to the pole 104.

FIG. 3B illustrates the clamp-based lock 330 in in a disengaged position 304. In the disengaged position 304, the inner surfaces of the attachment portions 122/142 can be separated further apart. For example, a distance d2 can be greater than the distance d1 of FIG. 3A. Accordingly, the compressing force against the pole 104 can be released and the attachment portions 122/142 can be moved or repositioned relative to the pole 104.

The attachment kit 100 (e.g., the forearm/elbow bed and the hand controller) provides increased control for using the landing net 102. The attachment kit 100 can provide a fulcrum at the forearm/elbow bed and a moment arm between the forearm/elbow bed and the hand controller. The moment arm increases the effect of the force applied by the user on the load (e.g., forces on the net/hoop) in comparison to just grabbing the pole with one hand. Further, the attachment kit 100 can allow the user to maneuver the hoop/net using larger/stronger muscles/joints, such as the biceps/shoulders/elbows instead of the forearm/hand muscles/wrist, thereby further increasing usability. As a result, a solo angler can operate the landing net with much less difficulty than a conventional landing net that does not include the attachment kit 100.

The attachment kit 100 is easy to assemble and use, at least in part because the fastening mechanism 130 allows the user affix the attachment kit 100 to the landing net 102 using his/her hand (i.e., without any tools). Based on enabling the user to operate the fastening mechanism 130 with his/her hand, the attachment kit 100 can be easily attached to existing landing nets. Further, the locations of the first/second portions on the pole can be easily adjusted, thereby allowing the user to dynamically adapt the attachment kit 100 according to a particular application, and/or can accommodate multiple users having different body sizes and/or shapes. The attachment kit 100 with the fastening mechanism 130 can be used to retrofit the traditional landing net 102 without requiring any tools. For example, the user can operate the fastening mechanism 130 with his/her hands and without drilling any holes into the traditional landing net 102. Since the user can affix/detach the attachment kit 100 using his/her hands and without any tools, the user can also easily change the attachment/fastening location of the attachment kit 100 relative to the landing net 102. As such, the attachment kit 100 with the fastening mechanism 130 allows the user to use/adapt one net for multiple fishing situations/conditions, such as when fishing from a big or a small boat, from the shore, while wading in the water, fishing salt/fresh water, etc.

The foregoing description of the present technology is not intended to be exhaustive or to limit the disclosed technology to the precise forms disclosed above. While specific examples of the disclosed technology are described above for illustrative purposes, various modifications are possible within the scope of the disclosed technology.

These and other changes can be made to the disclosed technology in light of the above Detailed Description. While the Detailed Description describes certain examples of the disclosed technology, the disclosed technology can be practiced in many ways, no matter how detailed the above description appears in text. Details of the system may vary considerably in its specific implementation, while still being encompassed by the technology disclosed herein.

From the foregoing, it will be appreciated that specific embodiments of the present technology have been described herein for purposes of illustration, but that various modifications may be made without deviating from the technology. For example, in some embodiments, the first and second portions 120 and 140 can be attached or integrally connected to each other, as discussed above. In any of these embodiments, the general aspects of the attachment kit can be similar to those described above so as to produce the operational efficiencies described above.

Certain aspects of the technology described in the context of particular embodiments may be combined or eliminated in other embodiments. Further, while advantages associated with certain embodiments of the technology have been described in the context of those embodiments, other embodiments may also exhibit such advantages, and not all embodiments need necessarily exhibit such advantages to fall within the scope of the present technology. Accordingly, the present disclosure and associates technology can encompass other embodiments not expressly shown or described herein.

As used herein, the phrase “and/or,” as in “A and/or B” refers to A alone, B alone, and both A and B. Also, as used herein, the term “generally” and “approximately” mean within ±10%, unless otherwise specified.

I/We claim:

1. An attachment kit configured to attach to a landing net, the attachment kit comprising:
a receptacle having a concave surface for contacting a user's forearm and/or elbow, and
a bed attachment portion operably connected to the receptacle, the bed attachment portion configured to contact a pole portion of the landing net.

2. The attachment kit of claim 1, wherein the bed attachment portion includes a hand-operable fastening mechanism configured to compress at least a portion of the bed attachment portion against the pole portion.

3. The attachment kit of claim 2, wherein:
the hand-operable fastening mechanism includes:
a bolt with a head positioned to prevent rotation of the bolt, and
a handle structure including a counter-sink receptacle operably couplable to the bolt; and
the bed attachment portion includes a head receptacle positioned to receive the head of the bolt.

4. The attachment kit of claim 2, wherein the hand-operable fastening mechanism includes a spring-based lock positioned to provide a compression force against the pole for affixing the handle attachment portion to the pole portion.

5. The attachment kit of claim 2, wherein the hand-operable fastening mechanism includes a clamp positioned to provide a compression force against the pole for affixing the handle attachment portion to the pole portion.

6. The attachment kit of claim 1, wherein:
the receptacle and the bed attachment portion comprise an arm bed; and
further comprising a hand controller including:
a handle attachment portion positioned to contact and attach to the pole portion of the landing net,
a handle portion operably connected to the handle attachment portion, the handle portion having a generally cylindrical shape positioned to contact a user's hand, and
a hand-operable fastening mechanism positioned to compress the handle attachment portion against the pole portion.

7. The attachment kit of claim 6, wherein the arm bed and the hand controller are separately attachable to the pole portion.

8. The attachment kit of claim 6, wherein:
the hand-operable fastening mechanism includes:
a bolt with a head positioned to prevent rotation of the bolt, and
a handle structure including a counter-sink receptacle operably couplable to the bolt; and
the handle attachment portion includes a head receptacle positioned to receive the head of the bolt.

9. The attachment kit of claim 6, wherein the hand-operable fastening mechanism includes a spring-based lock positioned to provide compression force against the pole for affixing the handle attachment portion to the pole portion.

10. The attachment kit of claim 6, wherein the hand-operable fastening mechanism includes a clamp positioned to provide compression force against the pole for affixing the handle attachment portion to the pole portion.

11. A landing net comprising:
a pole;
an open structure attached to an end of the pole;
a net attached to the open structure; and
an adjustable arm bed attached to the pole away from the open structure, wherein the adjustable arm bed includes:
a receptacle having a concave surface positioned to contact a user's forearm and/or elbow, and
a bed attachment portion operably connected to the receptacle, the bed attachment portion being in contact with the pole.

12. The landing net of claim 11, further comprising a hand-operable fastening mechanism carried by the adjustable arm bed and positioned to compress at least a portion of the bed attachment portion against the pole portion.

13. The landing net of claim 12, wherein:
the hand-operable fastening mechanism includes:
a bolt with a head positioned to prevent rotation of the bolt, and
a handle structure including a counter-sink receptacle operably couplable to the bolt; and
the bed attachment portion includes a head receptacle in which the head of the bolt is received.

14. The landing net of claim 12, wherein the hand-operable fastening mechanism includes a spring-based lock biased against the pole.

15. The landing net of claim 12, wherein the hand-operable fastening mechanism includes a clamp biased against the pole.

16. A landing net comprising:
a pole;
an open structure attached to an end of the pole;
a net attached to the open structure;
an arm bed attached to the pole away from the open structure; and
a hand controller attached to the pole between the arm bed and the open structure, wherein the hand controller includes:
a handle attachment portion attached to the pole portion of the landing net,
a handle portion operably connected to the handle attachment portion, the handle portion having a generally cylindrical shape positioned to contact a user's hand, and
a hand-operable fastening mechanism biasing the handle attachment portion against the pole portion.

17. The landing net of claim 16, wherein the arm bed and the hand controller are separately connected to the pole portion.

18. The landing net of claim 16, wherein:
the hand-operable fastening mechanism includes:
a bolt with a head positioned to prevent rotation of the bolt, and
a handle structure including a counter-sink receptacle operably couplable to the bolt; and
the handle attachment portion includes a head receptacle positioned to receive the head of the bolt.

19. The landing net of claim 16, wherein the hand-operable fastening mechanism includes a spring-based lock biasing against the pole to affix the handle attachment portion to the pole portion.

20. The landing net of claim 16, wherein the hand-operable fastening mechanism includes a clamp biasing against the pole to affix the handle attachment portion to the pole portion.
